(19) United States
(12) Patent Application Publication
(10) Pub. No.: US 2022/0095033 A1
(43) Pub. Date: Mar. 24, 2022

(54) ACOUSTIC DEVICE

(71) Applicant: Sony Group Corporation, Tokyo (JP)

(72) Inventors: Naoki Shinmen, Tokyo (JP); Yushi Yamabe, Tokyo (JP); Kohei Asada, Kanagawa (JP)

(73) Assignee: Sony Group Corporation, Tokyo (JP)

(21) Appl. No.: 17/426,622

(22) PCT Filed: Nov. 12, 2019
(86) PCT No.: PCT/JP2019/044410

§ 371 Date: Jul. 28, 2021

(30) Foreign Application Priority Data
Feb. 5, 2019 (JP) 2019-018482

(51) Int. Cl. H04R 1/10

(52) U.S. Cl. CPC H04R 1/1016; H04R 2460/01; H04R 1/1083

(57) ABSTRACT

Provided is an acoustic device worn on a listener's ear to be used that performs noise cancellation.

An acoustic device is provided with a sound insulation unit that engages with the ear canal and insulates ambient sound, a sound production unit that is arranged closer to the eardrum than the sound insulation unit and outputs an acoustic signal, a sound collection unit that is arranged in the vicinity of a sound insulation position in which the sound insulation unit insulates the ambient sound and collects the ambient sound, a processing unit that processes the acoustic signal according to the ambient sound collected by the sound collection unit, and a housing that accommodates the sound production unit, the sound collection unit, and the processing unit. The sound insulation unit includes an earpiece that supports the housing in the vicinity of an entrance of the ear canal.

### TECHNICAL FIELD

The technology disclosed in this specification relates to an acoustic device worn by a listener mainly on his/her ear to be used.

### BACKGROUND ART

A compact acoustic conversion device, that is, an earphone that converts an electric signal output from a reproduction device or a receiver into an acoustic signal by a speaker adjacent to the ear or the eardrum is widely used. An acoustic reproduction device of this type emits sound so that this may be heard only by a listener who wears the same, so that this device is utilized in various environments.

For example, a canal-type earphone has a shape in which an earpiece is deeply inserted into the ear canal. With the earphone of this type, a sound production element is generally arranged on a side opposite to the eardrum as seen from an ear canal engaging portion of the earpiece (refer to, for example, Patent Document 1).

Furthermore, in earphones and headphones, a noise canceling system that removes or reduces noise in an external environment to provide an excellent reproduction sound field space is known. For example, in an active noise reduction system that performs active noise reduction, external noise is collected by a microphone, and a noise canceling signal in a phase acoustically opposite to that of the noise is generated from an audio signal of the collected noise. The external noise is acoustically canceled by combining this noise canceling signal with an audio signal that is originally intended to be listened to of music and the like and acoustically reproducing the same by a speaker.

Noise cancellation includes a feedforward system and a feedback system. In the feedforward system, the sound (noise) collected in a position close to the ear is analyzed, a noise waveform in an eardrum position of the listener is predicted, and a signal (opposite phase waveform) that cancels the noise is generated. Furthermore, in the feedback system, noise canceling processing is performed on the sound (noise) collected in a housing by a microphone provided in the housing of the acoustic device (refer to Patent Document 2).

### CITATION LIST

### Patent Document

Patent Document 1: Japanese Patent Application Laid-Open No. 2016-86281
Patent Document 2: Japanese Patent Application Laid-Open No. 2016-174376

### SUMMARY OF THE INVENTION

### Problems to be Solved by the Invention

An object of the technology disclosed in this specification is to provide an acoustic device worn on the listener's ear to be used to perform noise cancellation.

### Solutions to Problems

The technology disclosed in this specification is

an acoustic device provided with:

a sound collection unit that is arranged in the vicinity of an entrance of an ear canal and collects ambient sound; and

a sound production unit that is arranged closer to an eardrum than the sound collection unit and outputs an acoustic signal.

The acoustic device is further provided with a sound insulation unit that engages with the ear canal and insulates the ambient sound, the sound production unit is arranged closer to the eardrum than the sound insulation unit, and the sound collection unit is arranged in the vicinity of a sound insulation position in which the sound insulation unit insulates the ambient sound. Furthermore, the acoustic device is further provided with a processing unit that performs feedforward noise cancelation on the basis of the ambient sound collected by the sound collection unit.

Furthermore, the acoustic device further includes a housing that accommodates the sound production unit, the sound collection unit, and the processing unit. The sound insulation unit includes an earpiece that supports the housing in the vicinity of the entrance of the ear canal, and supports the housing so that the sound production unit faces toward the eardrum.

### Effects of the Invention

According to the technology disclosed in this specification, it is possible to provide an acoustic device that is worn in the vicinity of an entrance of the ear canal of a listener to be used and performs noise cancellation by a feedforward system.

Note that, the effect described in this specification is illustrative only and the effect of the present invention is not limited to this. Furthermore, there also is a case in which the present invention further has an additional effect in addition to the above-described effect.

Still another object, feature, and advantage of the technology disclosed in this specification will become clear by further detailed description with reference to an embodiment to be described later and the attached drawings.

### BRIEF DESCRIPTION OF DRAWINGS

FIG. 1 is a view illustrating a basic configuration example of a noise canceling system 100.

FIG. 2 is a view illustrating an external configuration of an acoustic device 200.

FIG. 3 is a view illustrating an external configuration of a housing 210 alone.

FIG. 4 is a view illustrating a cross-sectional configuration of an earpiece 250.

FIG. 5 is a view illustrating a cross-section of the acoustic device 200.

FIG. 6 is a view illustrating a state in which the acoustic device 200 is worn on a listener's ear.

FIG. 7 is a view illustrating another example in which the acoustic device 200 is worn on the listener's ear.

FIG. 8 is a view illustrating a cross-section of the earpiece 250 configured to reduce a reaction force.

FIG. 9 is a view illustrating a cross-section of the earpiece 250 configured to reduce the reaction force (case where the housing 210 is mounted and the housing 210 is inclined).

FIG. 10 is a view illustrating another example of the cross-section of the earpiece 250 configured to reduce the reaction force.

FIG. 11 is a view illustrating another example of the cross-section of the earpiece 250 configured to reduce the reaction force (case where the housing 210 is mounted and the housing 210 is inclined).

FIG. 12 is a top view of the earpiece 250 configured so that the housing 210 is less likely to be inclined in an undesired direction.

FIG. 13 is a top view of the earpiece 250 configured so that the housing 210 is inclined only in a desired direction.

FIG. 14 is a view illustrating a modified example of the acoustic device 200.

FIG. 15 is a view illustrating a configuration example of a tubular portion 252 of the earpiece 250 used in the acoustic device 200 illustrated in FIG. 14.

FIG. 16 is a view illustrating another modified example of the acoustic device 200.

FIG. 17 is a view illustrating a configuration example of the acoustic device 200 in which the housing 210 is provided with a space for adjusting an acoustic characteristic.

FIG. 18 is a view illustrating another configuration example of the acoustic device 200 in which the housing 210 is provided with the space for adjusting the acoustic characteristic.

FIG. 19 is a view illustrating still another configuration example of the acoustic device 200 in which the housing 210 is provided with the space for adjusting the acoustic characteristic.

### MODE FOR CARRYING OUT THE INVENTION

An embodiment of the technology disclosed in this specification is hereinafter described in detail with reference to the drawings.

In this specification, a compact acoustic device having a feedforward noise canceling function worn on a listener's ear to be used such as a canal type is hereinafter proposed.

The acoustic device having the noise canceling function is provided with a sound production unit that reproduces a desired acoustic signal, a sound collection unit that collects ambient sound including noise and the like in an external environment, and a processing unit that processes the acoustic signal output from the sound collection unit according to the ambient sound collected by the sound collection unit.

The sound production unit is formed by a sound production element such as a dynamic speaker, a balanced armature, a piezo element, or an electrostatic speaker, for example, or by combining any two or more of a plurality of sound production elements.

The desired acoustic signal is a reproduction signal of music and the like, and is supplied from an external device such as a portable audio reproduction device or a multifunctional information terminal such as a smartphone and a tablet to the acoustic device, for example.

The sound collection unit includes a compact microphone, and collects the ambient sound including the noise and the like in the external environment generated while the sound production unit outputs the acoustic signal. In this embodiment, the sound collection unit is the microphone used for feedforward noise cancellation.

The processing unit generates a cancel signal that minimizes the ambient sound on the basis of the ambient sound collected by the sound collection unit. Specifically, this analyzes a waveform of a signal of the ambient sound collected by the sound collection unit and generates a signal in an opposite phase that cancels the ambient sound, and superimposes this opposite-phase signal on the ambient sound to cancel the ambient sound. This reduces the ambient sound in an eardrum position. In a case of the feedforward system, the processing unit estimates the waveform of the ambient sound when reaching the eardrum, and generates the cancel signal that minimizes the ambient sound on the basis of an estimation result.

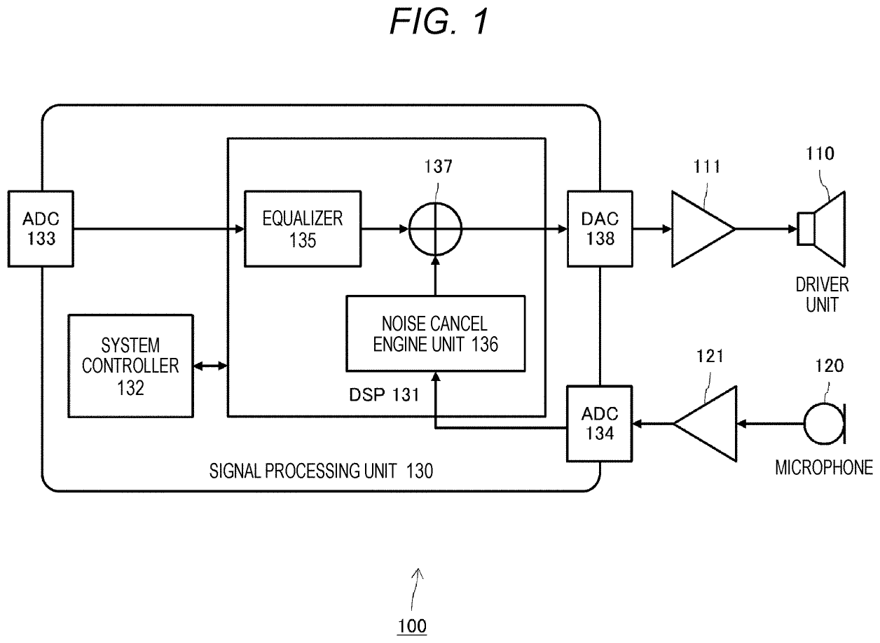

FIG. 1 illustrates a basic configuration example of a noise canceling system 100. Each unit is hereinafter described. The illustrated noise canceling system 100 is provided with a driver unit 110 as a sound production unit, a microphone 120 as a sound collection unit, and a signal processing unit 130 as a processing unit.

The signal processing unit 130 is provided with a digital signal processor (DSP) 131 and a system controller 132. The DSP 131 executes processing of an acoustic signal under control of the system controller 132.

When a reproduction signal of a music source is taken into the noise canceling system 100 via an audio input terminal (not illustrated), this is subjected to digital conversion by an AD converter (ADC) 133 and then input to the DSP 131. The music source herein referred to is an external device such as a portable audio reproduction device or a multifunctional information terminal such as a smartphone and a tablet and the like. However, in a case where an acoustic source transmits the reproduction signal wirelessly by Bluetooth (registered trademark), Wi-Fi and the like, this is only required to be equipped with a wireless interface in place of the audio input terminal and the AD converter 133.

Furthermore, an ambient sound signal including a noise in an external environment collected by the microphone 120 is amplified by a microphone amplifier 121, moreover subjected to digital conversion by an AD converter (ADC) 134, and then input to the DSP 131.

In the DSP 131, an equalizer 135 adjusts a frequency characteristic of the reproduction signal from the music source. Furthermore, a noise cancel engine unit 136 analyzes a waveform of the signal of the ambient sound taken in from the microphone 120 to generate a cancel signal in an opposite phase that cancels the ambient sound. In this embodiment, feedforward noise cancellation is performed, so that the noise cancel engine unit 136 predicts the waveform of the ambient sound in an eardrum position of a listener and generates the cancel signal that cancels the ambient sound. Note that, the noise cancel engine unit 136 may be implemented by software processing. Then, a combination unit 137 adds the cancel signal to the reproduction signal subjected to waveform shaping to generate a combined signal.

The combined signal output from the DSP 131 is subjected to analog conversion by a DA converter (DAC), moreover amplified by an earphone amplifier 111, and then acoustically output from the driver unit 110. The acoustic signal output from the driver unit 110 reaches the eardrum of the listener together with the ambient sound. Here, the cancel signal in the phase opposite to that of the ambient sound is superimposed on the acoustic signal (as described above). Therefore, when this cancel signal overlaps with the ambient sound, only the ambient sound is canceled, so that the listener may quietly enjoy music and the like.

The larger a correlation between the ambient sound signal observed by the microphone 120 and the ambient sound that actually reaches the eardrum, the larger a noise canceling effect. Therefore, by arranging the microphone 120 in the ear canal or in the vicinity of an entrance of the ear canal, the correlation between the ambient sound observed by the microphone 120 and the ambient sound that reaches the eardrum may be made larger.

The acoustic device with the noise canceling function proposed in this specification is assumed to be worn on the listener's ear to be used as the canal type. The compact acoustic device of this type is generally inserted in the vicinity of the entrance of the ear canal using an earpiece to be used. In this case, since the ambient sound is insulated by the earpiece to some extent, the ambient sound that leaks from the earpiece occupies most of the ambient sound that actually reaches the eardrum. Therefore, it may be said that, when the microphone 120 is arranged in the vicinity of a sound insulation position in which the ambient sound is insulated, in other words, in the vicinity of the earpiece, the correlation between the ambient sound signal observed by the microphone 120 and the ambient sound that reaches the eardrum becomes large, so that the noise canceling effect increases.

Furthermore, the acoustic device proposed in this specification is assumed to have the feedforward noise canceling function. When performing the feedforward noise cancellation, a frequency band in which the noise canceling effect may be obtained is determined by a relationship among a time t1 for a sound wave to propagate between the driver unit 110 and the eardrum, a time t2 for the ambient sound to propagate from the vicinity of the microphone 120 to the eardrum, and a processing time t3 of the ambient sound signal observed by the microphone 120. Note that, the time t3 corresponds to a time required for analyzing an input signal of the microphone 120, generating the cancel signal, and adding the cancel signal to the reproduction signal by the combination unit 137 to output in the signal processing unit 130. A time lag Δt of system input/output with respect to the ambient sound that should be canceled in the noise canceling system 100 is expressed by following equation (1).

$$\begin{matrix}[ Mathematical Equation 1 ] & \\ Δ t = t 3 - ( t 2 - t 1 ) & ( 1 )\end{matrix}$$

For example, in a case where it is intended to secure a noise canceling amount of 20 dB or larger at a certain frequency, it is considered that the above-described delay Δt should be suppressed within that corresponding to five degrees in phase of the signal to be canceled.

In the feedforward system, the microphone 120 is arranged outside an earphone (or headphone), but when this is arranged significantly outside the ear canal, the correlation between the ambient sound observed by the microphone 120 and the ambient sound that reaches the eardrum becomes small, which is not preferable. In a case where a position of the microphone 120 is made constant (in the vicinity of the sound insulation position), the time t2 becomes constant, so that the shorter the time t1 for the sound wave to propagate between the driver unit 110 and the eardrum, the more the frequency band at which the noise canceling effect may be obtained expands to a high frequency region.

A general noise canceling earphone has a structure in which a sound production element is arranged on a side opposite to the eardrum as seen from an ear canal engaging portion of an earpiece (for example, refer to Patent Document 1), a sound guide unit that extends from the sound production element toward the eardrum side is included, and the earpiece is attached to the sound guide unit. In this case, it takes time for the sound wave to propagate by a length of the earpiece. Furthermore, a microphone for detecting ambient sound is arranged significantly outside the ear canal.

On the other hand, the acoustic device proposed in this specification includes the earpiece as a sound insulation unit that engages with the ear canal to insulate the ambient sound, the driver unit 110 as the sound production unit arranged closer to the eardrum than the earpiece and outputs the reproduction signal of the music and the like, the microphone 120 as the sound collection unit arranged in the vicinity of the sound insulation position in which the ambient sound is insulated by the earpiece and collects the ambient sound, the signal processing unit 130 that processes the reproduction signal according to the ambient sound observed by the microphone 120, and a housing that accommodates the driver unit 110, the microphone 120, and the signal processing unit 130.

In the acoustic device proposed in this specification, the driver unit 110 is arranged closer to the eardrum than the engaging portion with the ear canal of the earpiece. Therefore, since a distance between the driver unit 110 and the eardrum is shortened, a phase delay in a propagation path of the sound wave output from the driver unit 110 is reduced, so that the frequency band in which the noise canceling effect may be obtained may be expanded to the high frequency region. It may also be said that, by arranging the driver unit 110 closer to the eardrum than the sound insulation position by the earpiece, it is possible to suppress an effect by the delay to improve the noise canceling effect.

Furthermore, in the acoustic device proposed in this specification, the microphone 120 is arranged in the vicinity of the sound insulation position in which the ambient sound is insulated by the earpiece. The noise that is wanted to be canceled is the ambient sound that leaks from the earpiece and reaches the eardrum. Therefore, by optimally arranging the microphone 120 in the vicinity of the sound insulation position, it becomes possible to observe the ambient sound that is wanted to be actually canceled by the microphone 120. That is, the correlation between the ambient sound signal observed by the microphone 120 and the ambient sound that reaches the eardrum becomes large, and the noise canceling effect may be made large.

In addition, the ambient sound that leaks from the earpiece and reaches the eardrum that is to be canceled actually is the acoustic signal affected by reflections from the auricle, the head, and the body of the listener who wears the acoustic device. In this embodiment, since the sound insulation position in which the microphone 120 is arranged corresponds to the vicinity of the entrance of the ear canal, the microphone 120 may observe the ambient sound affected by the reflections from the auricle, the head, and the body of the listener who wears the acoustic device, and from this point of view also, the noise canceling effect may be improved.

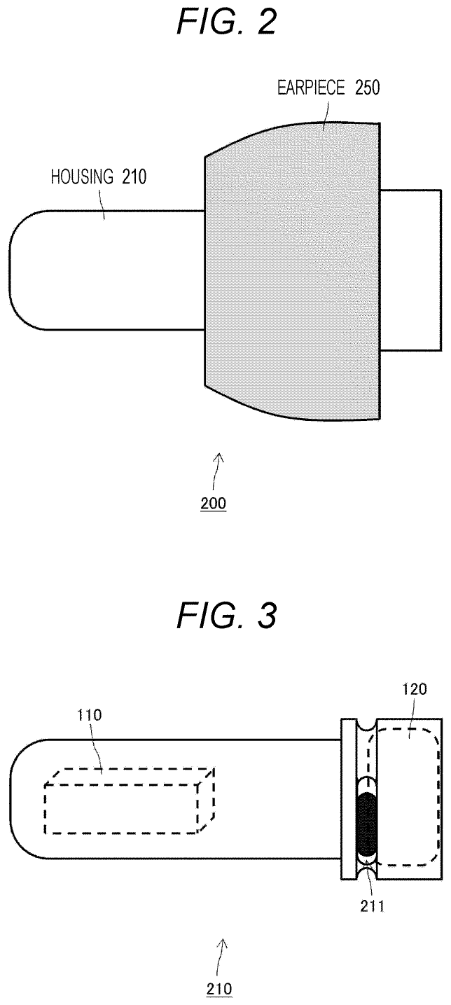

FIG. 2 illustrates an external configuration of an acoustic device 200 according to this embodiment. The acoustic device 200 includes a housing 210 and an earpiece 250.

The housing 210 incorporates the driver unit 110, the microphone 120, the signal processing unit 130, and a battery as a drive power source of the respective units (none of them is illustrated in FIG. 2). Furthermore, an earphone cable for taking in the reproduction signal from the external device (music source) such as the portable audio reproduction device or the multifunctional information terminal such as the smartphone and the tablet may be connected to the housing 210, but this is not illustrated in FIG. 2 for simplicity.

FIG. 3 illustrates an external configuration of the housing 210 alone. The housing 210 has a hollow cylindrical shape and incorporates therein the driver unit 110, the microphone 120, the signal processing unit 130, and the battery as the drive power source of the respective units. The housing 210 is formed by using elastic or plastic silicone rubber or elastomer, plastic such as acrylonitrile butadiene styrene (ABS), or metal.

In FIG. 3, an arrangement example of the driver unit 110 and the microphone 120 as acoustic elements is indicated by broken lines. The position of the driver unit 110 is closer to the eardrum than the engaging portion with the ear canal of the earpiece 250. Furthermore, the position of the microphone 120 is in the vicinity of the sound insulation position in which the ambient sound is insulated by the earpiece 250. One or more sound holes 211 for the microphone 120 to take in the ambient sound are bored on a wall surface in the vicinity of the position in which the microphone 120 is arranged of the housing 210.

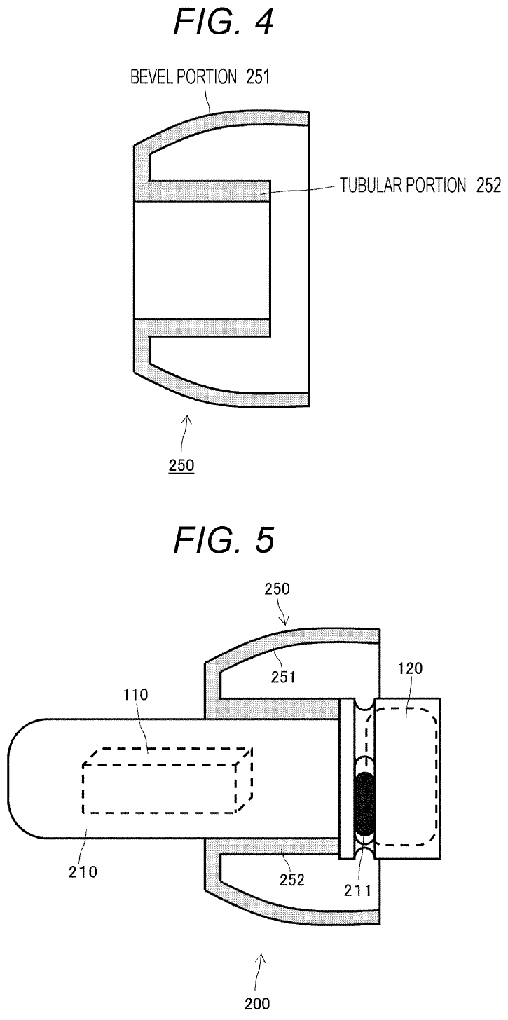

FIG. 4 illustrates a cross-sectional configuration of the earpiece 250. The earpiece 250 includes a bevel portion 251 that engages with an inner wall of the ear canal and a tubular portion 252 that holds the housing 210. The earpiece 250 is formed by using elastic or plastic silicone rubber and elastomer and the like.

FIG. 5 illustrates a state in which the housing 210 is attached to the cross-section of the earpiece 250. Both the housing 210 and the earpiece 250 have substantially rotational shapes, and the housing 210 is supported by the tubular portion 252 so that a central axis of the housing 210 substantially coincides with a central axis of the earpiece 250. The earpiece 250 may also have an elliptical shape or a shape that follows a shape of the ear canal. Furthermore, when the acoustic device 200 is worn on the listener's ear in a state in which the housing 210 is attached to the earpiece 250, the position of the driver unit 110 is closer to the eardrum than the engaging portion with the ear canal of the earpiece 250, and the position of the microphone 120 is in the vicinity of the sound insulation position in which the ambient sound is insulated by the earpiece 250.

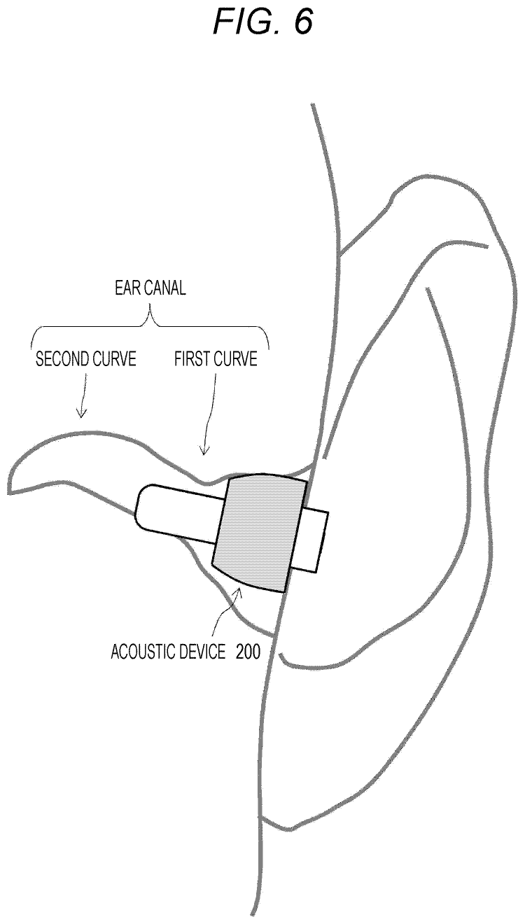

FIG. 6 illustrates a state in which the acoustic device 200 illustrated in FIGS. 2 to 5 is worn on the listener's ear. The ear canal has a length of about 2.5 to 3 centimeters from the entrance to the eardrum and is curved into an S shape to prevent a foreign matter from entering. A curve closer to the entrance is referred to as a first curve, and a curve in the back is referred to as a second curve. Therefore, the acoustic device 200 cannot be inserted deeply unless this has a shape that follows the ear canal (first curve). When this cannot be inserted deeply, the distance between the driver unit 110 and the eardrum becomes long, and the sound wave propagation time t1 becomes longer by that amount, so that the noise canceling effect is reduced.

When the acoustic device 200 is configured so that the central axis of the housing 210 may be inclined at any angle (at least within a certain angle range) with respect to the central axis of the earpiece 250, it becomes possible to insert the acoustic device 200 deeper into the ear canal (in other words, to the vicinity of the eardrum).

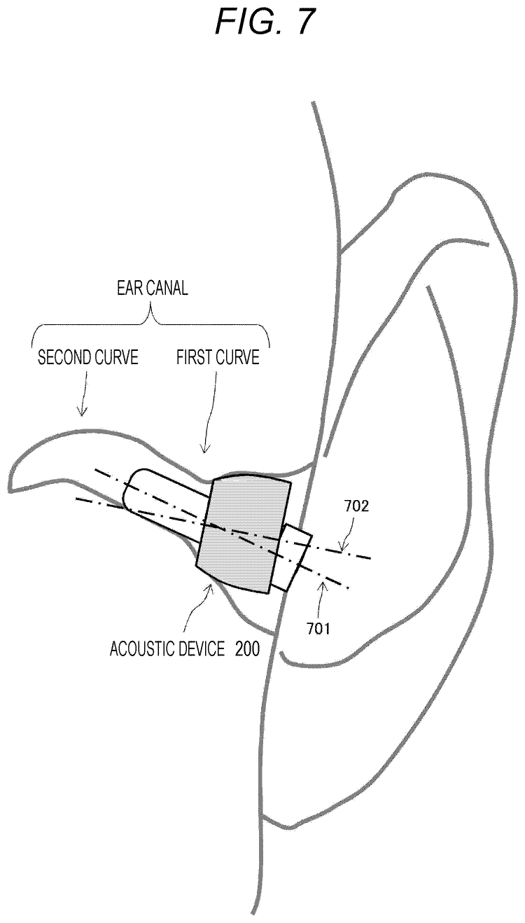

FIG. 7 illustrates another example in which the acoustic device 200 is worn on the listener's ear. Here, a central axis 701 of the housing 210 with respect to the earpiece 250 is configured to be variable. When the central axis 701 of the housing 210 is inclined with respect to a central axis 702 of the earpiece 250 so as to follow the shape of the ear canal (first curve), the acoustic device 200 may be inserted deeper into the ear canal than in the example illustrated in FIG. 6.

As illustrated in FIG. 4, the earpiece 250 is provided with the bevel portion 251 that abuts the inner wall of the ear canal and the tubular portion 252. Then, by insertion of the housing 210 into the hollow tubular portion 252, the housing 210 is supported by the earpiece 250. Therefore, it is sufficient to configure so that the earpiece 250 supports the housing 210 so that an inclination angle of the central axis of the housing 210 is variable with respect to a central axis of the bevel portion 251.

By forming the earpiece 250 by using the elastic or plastic silicone rubber and the elastomer and the like, the earpiece 250 may support the housing 210 so that the inclination angle is variable. Furthermore, by also forming the housing 210 by using the elastic or plastic silicone rubber and elastomer and the like, a tip end of the housing 210 may also abut the inner wall of the ear canal and follow the shape of the ear canal (first curve).

However, since a reaction force acts according to the angle at which the central axis of the housing 210 is inclined with respect to the central axis of the bevel portion 251, the reaction force is applied to a wall surface of the ear canal via the bevel portion 251, so that this becomes a physical burden on the listener who wears the acoustic device 200.

Therefore, the earpiece 250 may also be configured so as to reduce the reaction force acting when the central axis of the housing 210 is inclined with respect to the central axis of the bevel portion 251.

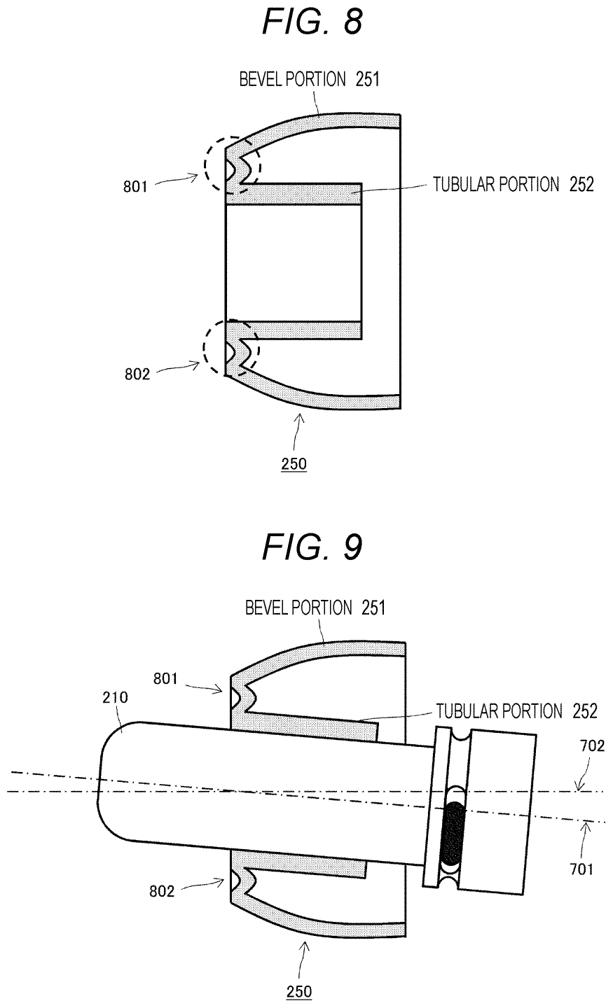

FIG. 8 illustrates a cross-section of the earpiece 250 configured to reduce the reaction force when the housing 210 is inclined. In the illustrated example, as represented by reference numerals 801 and 802, a wave front shape centered on the central axis is formed on a tip end face of the earpiece 250. Therefore, the tip end face of the earpiece 250 strength of which is reduced is easily bent in a radial direction. As a result, the tubular portion 251 tends to easily bend with respect to the tip end face, and the reaction force when the housing 210 is inclined decreases.

FIG. 9 illustrates a state in which the housing 210 is attached to the cross-section of the earpiece 250 illustrated in FIG. 8. Since wave front-shaped portions 801 and 802 on the tip end face of the earpiece 250 are easily deformable, even if the central axis 701 of the housing 210 is inclined with respect to the central axis 702 of the earpiece 250 as illustrated, the reaction force to return the central axis 701 of the housing 210 to the central axis 702 of the earpiece 250 is reduced.

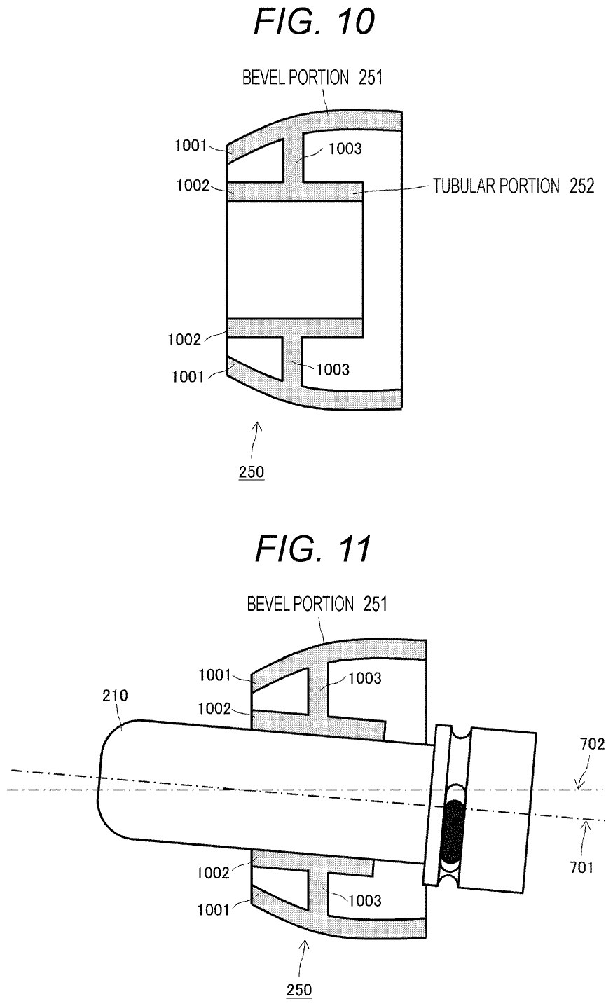

Furthermore, FIG. 10 illustrates another example of the cross-section of the earpiece 250 configured to reduce the reaction force when the housing 210 is inclined. In the illustrated example, the cross-section of the earpiece 250 is formed into an H shape, and the tubular portion 252 is formed on a web 1003 interposed between flanges 1001 and 1002 at both ends of the H shape to support the earpiece 210. Comparing FIG. 10 with FIG. 4, a fulcrum when the tip end of the housing 210 abuts the wall surface of the ear canal and a moment is generated is set back from the tip end face of an in piece 250 to the web 1003 in substantially the center. Therefore, in a case where an external force is applied from the wall surface of the ear canal, the tip end of the earpiece 250 is larger in the configuration example illustrated in FIG. 10 and the inclination angle thereof also becomes larger. In other words, when the central axis of the housing 210 is inclined by the same angle with respect to the central axis of the bevel portion 251, the reaction force that acts may be reduced in the configuration example illustrated in FIG. 10 as compared with that in FIG. 4.

FIG. 11 illustrates a state in which the housing 210 is attached to the cross-section of the earpiece 250 illustrated in FIG. 10. Unlike in FIG. 8, the cross-section of the earpiece 250 has the H shape, the tip end face of the earpiece 250 becomes an opening, and the web 1003 that supports the tubular portion 252 is easily deformable with respect to the flanges 1001 and 1002. Furthermore, by an amount of setback of the fulcrum when the central axis 701 of the housing 210 is inclined with respect to the central axis 702 of the earpiece 250 as illustrated, the reaction force to return the central axis 701 of the housing 210 to the central axis 702 of the earpiece 250 is reduced. Furthermore, by reducing a plate thickness of the web 1003, the reaction force may be further reduced.

On the other hand, in a case where it is configured that the reaction force when the housing 210 is inclined with respect to the earpiece 250 is reduced, the housing 210 is easily inclined at any angle with respect to the earpiece 250, and there is a concern that the housing 210 bends in an unnecessary direction and it takes time and effort when this is worn on the listener's ear. Therefore, the earpiece 250 may be configured so that the housing 210 is less likely to be inclined in an undesired direction, or is inclined only in a desired direction.

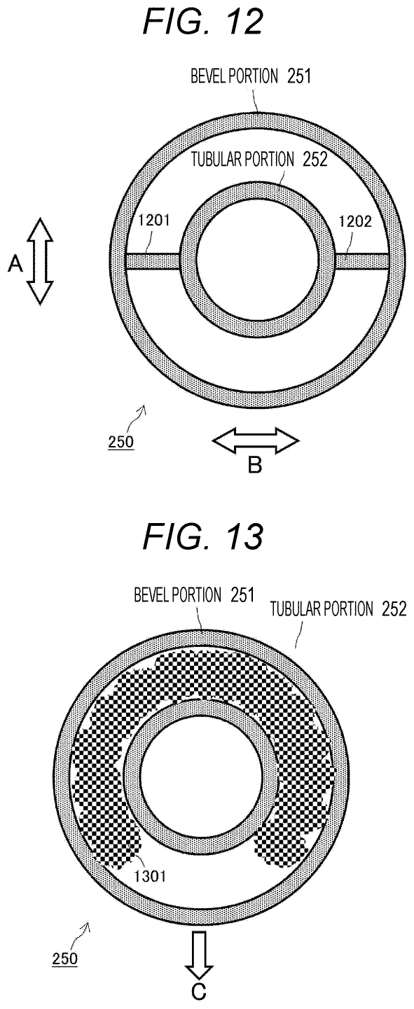

FIG. 12 illustrates a top view of the earpiece 250 configured so that the housing 210 is less likely to be inclined in the undesired direction. In the illustrated earpiece 250, a pair of ribs 1201 and 1202 are formed between the bevel portion 251 and the tubular portion 252. Therefore, the tubular portion 252 (or the housing 210 supported by the tubular portion 252 (not illustrated in FIG. 12)) is still easily inclined in an A direction, but is difficult to be inclined in a B direction.

Furthermore, FIG. 13 illustrates a top view of the earpiece 250 configured so that the housing 210 is inclined only in the desired direction. In the illustrated earpiece 250, a space between the bevel portion 251 and the tubular portion 252 is filled with an elastic body such as a sponge 1301. Therefore, the tubular portion 252 (or the housing 210 supported by the tubular portion 252 (not illustrated in FIG. 13)) tends to be inclined in a C direction in which there is a gap of the sponge 1301, but is inclined in other directions with a high load.

Subsequently, an internal configuration of the housing 210 is described in detail.

As illustrated in FIG. 3, the housing 210 has the hollow cylindrical shape, and accommodates the driver unit 110 and the microphone 120 therein. Furthermore, although not illustrated in FIG. 3, the signal processing unit 130 that performs the processing such as the noise cancellation and the battery as the drive power source are also arranged in the housing 210.

The position of the driver unit 110 is closer to the eardrum than the engaging portion with the ear canal of the earpiece 250. Since the distance between the driver unit 110 and the eardrum is shortened, the phase delay in the propagation path of the sound wave output from the driver unit 110 is reduced, so that the frequency band in which the noise canceling effect may be obtained may be expanded to the high frequency region. It may also be said that it is possible to suppress an influence by the delay and improve the noise canceling effect by arranging the driver unit 110 closer to the eardrum than the sound insulation position by the earpiece 250.

Furthermore, the position of the microphone 120 is in the vicinity of the sound insulation position in which the ambient sound is insulated by the earpiece 250. One or more sound holes 211 for the microphone 120 to take in the ambient sound are bored on a wall surface in the vicinity of the position in which the microphone 120 is arranged of the housing 210. The noise that is wanted to be canceled is the ambient sound that leaks from a clearance of the earpiece 250 into the ear canal and reaches the eardrum. Therefore, when the microphone 120 collects the ambient sound in the vicinity of the sound insulation position of the earpiece 250, the ambient sound that is wanted to be actually canceled may be observed by the microphone 120. That is, the correlation between the ambient sound signal observed by the microphone 120 and the ambient sound that reaches the eardrum becomes large, and the noise canceling effect may be made large.

The ambient sound that leaks from the earpiece and reaches the eardrum that is to be canceled actually is the acoustic signal affected by reflections from the auricle, the head, and the body of the listener who wears the acoustic device. As is clear from FIG. 6 or 7, since the sound hole 211 of the microphone 120 is arranged in the vicinity of the entrance of the ear canal, the microphone 120 may observe the ambient sound affected by the reflections from the auricle, the head, and the body of the listener who wears the acoustic device, and from this point of view also, the noise canceling effect may be improved.

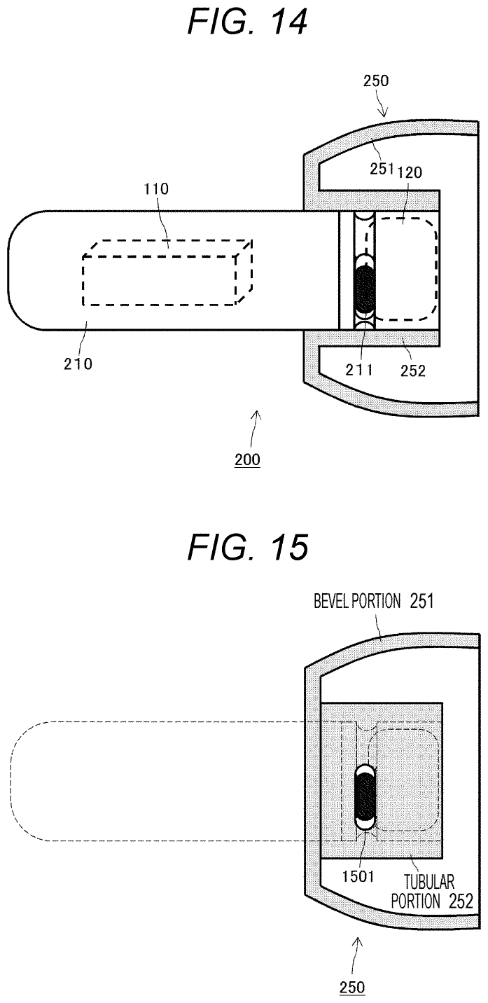

FIG. 14 illustrates a modified example of the acoustic device 200. In a configuration example of the acoustic device 200 illustrated in FIG. 5, a rear end of the housing 210 projects from the tubular portion 252 of the earpiece 250. On the other hand, in a configuration example of the acoustic device 200 illustrated in FIG. 14, the housing 210 is inserted into the tubular portion 252 up to the rear end, and the drive unit 110 on a tip end side may be brought closer to the eardrum by that amount, so that the noise canceling effect is improved. Furthermore, the position in which the microphone 120 is arranged is also covered with the tubular portion 252. Therefore, as illustrated in FIG. 15, a sound hole 1501 for the microphone 120 is also bored on a wall surface of the tubular portion 252 corresponding to the sound hole 211.

It is also possible to install a compact microphone in order to improve volumetric efficiency. FIG. 16 illustrates a configuration example of the acoustic device 200 in which the microphone 120 made compact is arranged deep inside the earpiece 250.

In an acoustic output device such as a speaker, it is common practice to provide a space for adjusting an acoustic characteristic on a front surface or a back surface of a diaphragm.

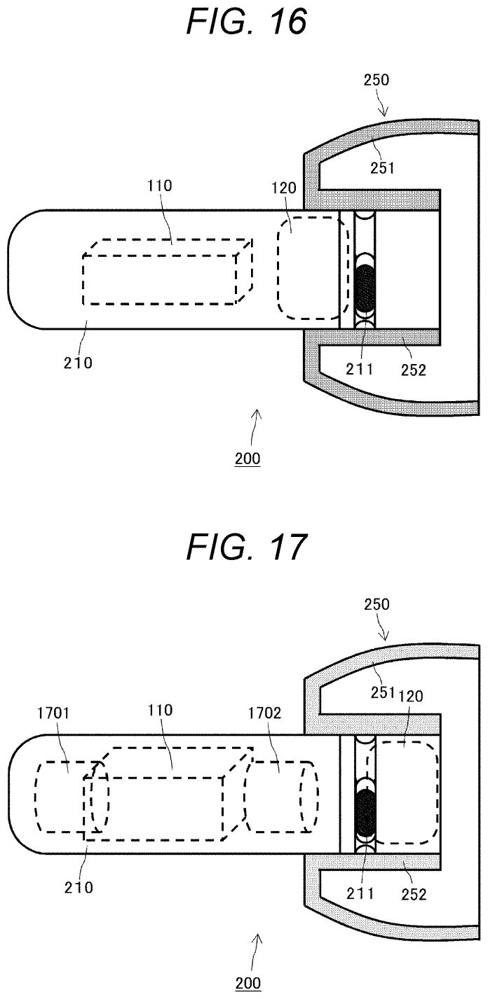

In the acoustic device 200 according to this embodiment, similarly, it is preferable to provide the space for adjusting the acoustic characteristic. FIG. 17 illustrates a state in which a front surface space 1701 and a back surface space 1702 are provided on an eardrum side and a side opposite to the eardrum of the driver unit 110 in the housing 210, respectively.

In a case where the acoustic device 200 is accommodated in the ear canal, it is assumed to be difficult to provide the space in the housing 210 for adjusting the acoustic characteristic on the front surface or the back surface of the driver unit 110. Therefore, it is possible to provide the space for adjusting the acoustic characteristic in an arbitrary place in the housing 210 and connect the space and the tip end on the eardrum side of the housing 210 by the sound guide unit.

FIG. 18 illustrates another configuration example of the acoustic device 200 in which the housing 210 is provided with the space for adjusting the acoustic characteristic. In the drawing, in the housing 210, a front surface space 1801 is provided on a side opposite to the eardrum of the driver unit 110, and a tube-shaped sound guide unit 1802 connects the front surface space 1801 and the tip end on the eardrum side of the housing 210 to secure the space for adjusting the acoustic characteristic.

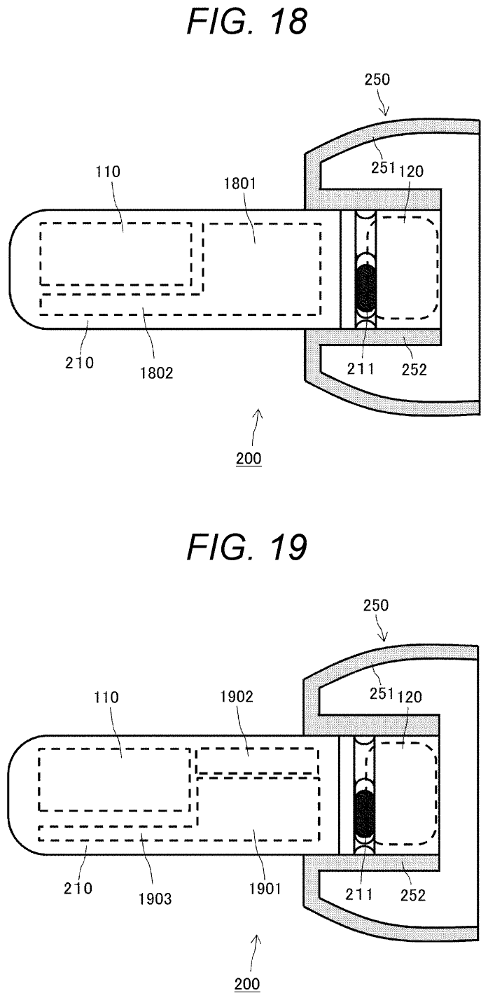

FIG. 19 illustrates still another configuration example of the acoustic device 200 in which the housing 210 is provided with the space for adjusting the acoustic characteristic. In the drawing, in the housing 210, both front surface space 1901 and back surface space 1902 are provided on a side opposite to the eardrum of the driver unit 110 to secure the space for adjusting the acoustic characteristic. Furthermore, a tube-shaped sound guide unit 1903 connects the front surface space 1901 and the tip end on the eardrum side of the housing 210.

Arrangement of the processing unit 130 and the battery in the housing 210 is not especially mentioned so far. Unlike the acoustic elements such as the driver unit 110 and the microphone 120, the processing unit 130 and the battery are not restricted in arrangement in terms of the acoustic characteristic. Therefore, for example, the processing unit 130 and the battery may be combined and handled as a module, and may be separately arranged along with the driver unit 110 and the microphone 120 in the housing 210. It is possible to realize the acoustic device 200 that is comfortable to wear by making relative positions of the respective modules be changeable even slightly according to deformation of the housing 210 by electrically connecting the modules using a flexible wiring material, and forming the housing 210 by using elastic members such as silicone rubber and elastomer.

Note that, as the processing unit 130 and the battery, those of the external device serving as the music source may be used. The music source is the portable audio reproduction device or the multifunctional information terminal such as the smartphone and the tablet, for example. In such a case, a cord that electrically connects to the driver unit 110 and the microphone 120 comes from the housing 210 and is connected to the external device.

Furthermore, the acoustic device 200 may also be configured so that the processing unit 130 and the battery mounted in the housing 210 may be switched to the external device connected by wire (or wirelessly) to be used. For example, the housing 210 may be equipped with a connector capable of connecting to each of the processing unit 130 and the battery therein and the external device and have an exchanging function of alternatively connecting to any one of them.

Finally, the effects of the acoustic device proposed in this specification are summarized.

According to the acoustic device proposed in this specification, by arranging the driver unit 110 on the eardrum side, the distance between the driver unit 110 and the eardrum is shortened, and the phase delay in the propagation path of the sound wave is reduced, so that the noise canceling effect may be obtained up to the high frequency region.

Furthermore, according to the acoustic device proposed in this specification, the microphone 120 is arranged in the vicinity of the sound insulation position in which the ambient sound is insulated by the earpiece, and the ambient sound that is wanted to be actually canceled is observed by the microphone 120, so that the noise canceling effect may be made large. Furthermore, since the microphone 120 is arranged in the vicinity of the entrance of the ear canal, this observes the ambient sound affected by the reflections from the auricle, the head, and the body of the listener who wears the acoustic device, so that the noise canceling effect is further improved.

### INDUSTRIAL APPLICABILITY

The technology disclosed in this specification is heretofore described in detail with reference to the specific embodiment. However, it is obvious that one skilled in the art may modify or substitute the embodiment without departing from the scope of the technology disclosed in this specification.

The technology disclosed in this specification is applicable to various types of acoustic devices worn on the listener's ear to be used and perform the noise cancellation.

In short, the technology disclosed in this specification is heretofore described in a form of an example and the content described in this specification should not be interpreted in a limited manner. In order to determine the gist of the technology disclosed in this specification, claims should be taken into consideration.

Note that, the technology disclosed in this specification may also have the following configuration.

(1) An acoustic device provided with:

a sound collection unit that is arranged in the vicinity of an entrance of an ear canal and collects ambient sound; and a sound production unit that is arranged closer to an eardrum than the sound collection unit and outputs an acoustic signal.

(1-1) An acoustic device provided with:

a sound insulation unit that engages with an ear canal and insulates ambient sound;

a sound production unit that is arranged closer to an eardrum than the sound insulation unit and outputs an acoustic signal; and

a sound collection unit that is arranged in a vicinity of a sound insulation position in which the sound insulation unit insulates the ambient sound and collects the ambient sound.

(3) The acoustic device according to (1) above, further provided with:

a sound insulation unit that engages with the ear canal and insulates the ambient sound, in which

the sound production unit is arranged closer to the eardrum than the sound insulation unit, and

the sound collection unit is arranged in the vicinity of a sound insulation position in which the sound insulation unit insulates the ambient sound.

(3) The acoustic device according to (2) above, further provided with:

a processing unit that processes the acoustic signal according to the ambient sound collected by the sound collection unit.

(4) The acoustic device according to (3) above, in which the processing unit performs noise cancellation on the basis of the ambient sound collected by the sound collection unit.

(4-1) The acoustic device according to (4) above, in which the processing unit performs feedforward noise cancellation.

(5) The acoustic device according to (3) above, further provided with:

a housing that accommodates the sound production unit, the sound collection unit, and the processing unit.

(6) The acoustic device according to (5) above, in which the sound insulation unit includes an earpiece that supports the housing in the vicinity of the entrance of the ear canal.

(7) The acoustic device according to (6) above, in which the earpiece supports the housing so that the sound production unit faces toward the eardrum.

(8) The acoustic device according to any one of (6) and (7) above, in which

the housing has a substantially cylindrical shape, and

the earpiece supports the housing so that an inclination angle of a central axis of the housing is variable.

(9) The acoustic device according to (8) above, in which

the earpiece is provided with a bevel portion that abuts an inner wall of the ear canal and a tubular portion that holds the housing inside the bevel portion, and supports the housing so that the inclination angle of the central axis of the housing with respect to a central axis of the bevel portion is variable.

(10) The acoustic device according to any one of (6) to (9) above, in which

in the housing, a sound hole for the sound collection unit is bored in the vicinity of the sound insulation position in which the earpiece insulates the ambient sound.

(11) The acoustic device according to (10) above, in which

the earpiece is provided with a bevel portion that abuts an inner wall of the ear canal and a tubular portion that holds the housing inside the bevel portion, and

the sound hole is arranged inside the bevel portion.

(12) The acoustic device according to (11) above, in which

the earpiece is provided with the tubular portion that holds the housing inside the bevel portion, and

the tubular portion includes an opening in a place corresponding to the sound hole.

(13) The acoustic device according to any one of (5) to (12) above, in which

the housing includes at least one of a front surface space and a back surface space for adjusting an acoustic characteristic of sound output from the sound production unit.

(14) The acoustic device according to (13) above, in which

the housing is provided with the front surface space and a sound guide unit that extends from the front surface space to a tip end on an eardrum side of the housing.

(15) The acoustic device according to (13) above, in which

the housing is provided with the front surface space and the back surface space at the back.

### REFERENCE SIGNS LIST

100 Noise canceling system
110 Driver unit
111 Earphone amplifier
120 Microphone
121 Microphone amplifier
130 Signal processing unit
131 DSP (Digital Signal Processor)
132 System controller
133 AD converter (ADC)
134 AD converter (ADC)
135 Equalizer
136 Noise cancel engine unit
137 Combination unit
138 DA converter (DAC)
200 Acoustic device
210 Housing
211 Sound hole
250 Earpiece
251 Bevel portion
252 Tubular portion

1. An acoustic device comprising:
a sound collection unit that is arranged in a vicinity of an entrance of an ear canal and collects ambient sound; and
a sound production unit that is arranged closer to an eardrum than the sound collection unit and outputs an acoustic signal.

2. The acoustic device according to claim 1, further comprising:
a sound insulation unit that engages with the ear canal and insulates the ambient sound, wherein
the sound production unit is arranged closer to the eardrum than the sound insulation unit, and
the sound collection unit is arranged in a vicinity of a sound insulation position in which the sound insulation unit insulates the ambient sound.

3. The acoustic device according to claim 2, further comprising:
a processing unit that processes the acoustic signal according to the ambient sound collected by the sound collection unit.

4. The acoustic device according to claim 3, wherein
the processing unit performs noise cancellation on a basis of the ambient sound collected by the sound collection unit.

5. The acoustic device according to claim 3, further comprising:
a housing that accommodates the sound production unit, the sound collection unit, and the processing unit.

6. The acoustic device according to claim 5, wherein
the sound insulation unit includes an earpiece that supports the housing in the vicinity of the entrance of the ear canal.

7. The acoustic device according to claim 6, wherein
the earpiece supports the housing so that the sound production unit faces toward the eardrum.

8. The acoustic device according to claim 6, wherein
the housing has a substantially cylindrical shape, and
the earpiece supports the housing so that an inclination angle of a central axis of the housing is variable.

9. The acoustic device according to claim 8, wherein
the earpiece is provided with a bevel portion that abuts an inner wall of the ear canal and a tubular portion that holds the housing inside the bevel portion, and supports the housing so that the inclination angle of the central axis of the housing with respect to a central axis of the bevel portion is variable.

10. The acoustic device according to claim 6, wherein
in the housing, a sound hole for the sound collection unit is bored in the vicinity of the sound insulation position in which the earpiece insulates the ambient sound.

11. The acoustic device according to claim 10, wherein
the earpiece is provided with a bevel portion that abuts an inner wall of the ear canal and a tubular portion that holds the housing inside the bevel portion, and
the sound hole is arranged inside the bevel portion.

12. The acoustic device according to claim 11, wherein
the earpiece is provided with the tubular portion that holds the housing inside the bevel portion, and
the tubular portion includes an opening in a place corresponding to the sound hole.

13. The acoustic device according to claim 5, wherein
the housing includes at least one of a front surface space and a back surface space for adjusting an acoustic characteristic of sound output from the sound production unit.

14. The acoustic device according to claim 13, wherein
the housing is provided with the front surface space and a sound guide unit that extends from the front surface space to a tip end on an eardrum side of the housing.

15. The acoustic device according to claim 13, wherein
the housing is provided with the front surface space and the back surface space at a back.
